(19) United States
(12) Patent Application Publication
(10) Pub. No.: US 2005/0185122 A1
(43) Pub. Date: Aug. 25, 2005

(54) Autostereoscopic display having a wave-selective filter arranged between a liquid crystal unit and a front polarizer

(75) Inventor: Ralf Edelbrock, Karlsruhe (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 11/043,930

(22) Filed: Jan. 28, 2005

(30) Foreign Application Priority Data
Jan. 28, 2004 (DE) 10 2004 004 282.9

(51) Int. Cl. G02F 1/1335

(52) U.S. Cl. 349/115

(57) ABSTRACT

An autostereoscopic display includes a back polarizer (BP) supplied with light from a backlight (BL), a liquid crystal unit (FE) disposed downstream of the back polarizer (BP), a wave-selective filter (WF) and a front polarizer (FP) with an anti-reflective coating (AS). The wave-selective filter (WF) is arranged between the liquid crystal unit (FE) and the front polarizer (FP), so as to avoid interfering influences on the sharpness of the image by the anti-reflective coating (AS).

The following disclosure is based on German Patent Application No. 10 2004 004 282.9, filed on Jan. 28, 2004, which is incorporated into this application by reference.

### FIELD AND BACKGROUND OF THE INVENTION

The invention relates to an autostereoscopic display including a back polarizer which receives light from a backlight, a liquid crystal unit disposed downstream of the back polarizer, a wave-selective filter and a front polarizer with an anti-reflective coating.

In order to spatially display an image, e.g., an image of an object, on an autostereoscopic display, an image-recording device must first record a plurality of views of this object from different positions. For example, four recorded views are sufficient for a proper spatial display on the autostereoscopic display screen. The autostereoscopic display is provided with software to process the image recordings transmitted to the display. If four views of the image were recorded, the software assigns the four views to a pixel field of the display. The pixel field has a plurality of elementary pixels, each of which includes at least one red subpixel, one green subpixel and one blue subpixel. A wave-selective filter (slotted shadow mask filter disk) causes a viewer to perceive one of the four views on the display with each eye depending on the viewer's head movement. Since the front polarizer is disposed between the liquid crystal unit and the wave-selective filter, the anti-reflective coating, which is applied to the front polarizer and which usually has a light scattering effect, may “mix” several views of the image. Accordingly, the viewer will perceive the image as blurred.

### OBJECTS OF THE INVENTION

One object of the present invention is to provide an autostereoscopic display, as described above, that avoids interfering influences on the sharpness of the image caused by the anti-reflective coating.

### SUMMARY OF THE INVENTION

This and other objects are attained, according to one formulation of the invention, by arranging the wave-selective filter between the liquid crystal unit and the front polarizer.

Because the front polarizer is now disposed downstream of the wave-selective filter, the light passes through the wave-selective filter unhindered, thereby avoiding “mixing” of the views. Thus, an anti-reflective coating applied to the front polarizer will scatter only the sharp image. When compared to prior-art autostereoscopic displays in which the front polarizer is disposed between the liquid crystal unit and the wave-selective filter, the sharpness of the image is substantially improved. Furthermore, an anti-reflective coating disposed downstream of the wave-selective filter and the front polarizer will improve the glare suppression of the autostereoscopic display.

In one non-limiting embodiment of the invention, the wave-selective filter, the front polarizer and the anti-reflective coating are components of a composite unit that is provided with a pane of glass. The glass pane is disposed between the wave-selective filter and the front polarizer to stabilize the front polarizer. An advantage of this arrangement is that, if the glass pane is accidentally destroyed, the anti-reflective coating prevents the glass particles from getting outside the display. This type of display is particularly suitable for use in the medical field.

### BRIEF DESCRIPTION OF THE DRAWINGS

The invention, its embodiments and advantages will now be described in greater detail with reference to an exemplary embodiment of the invention depicted in the drawing, in which:

FIG. 1 is a schematic diagram illustrating parts of an autostereoscopic display panel consistent with the present invention;

FIG. 2 is a schematic diagram of an autostereoscopic display panel consistent with the present invention; and

FIG. 3 is a schematic diagram illustrating parts of a prior art autostereoscopic display panel.

### DETAILED DESCRIPTION OF THE PREFERRED EMBODIMENTS

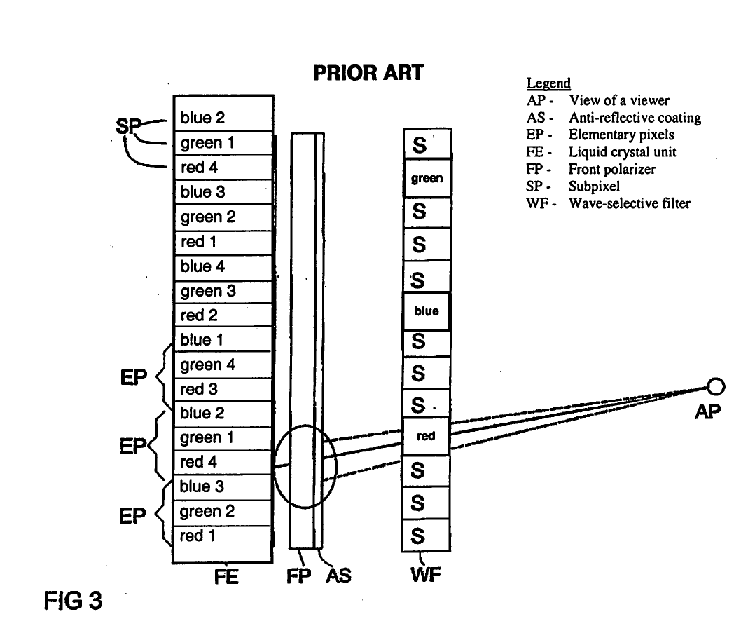

FIG. 3 shows parts of a prior-art autostereoscopic display device. For simplicity, the figure shows only a view AP of a viewer looking at an image displayed on a liquid crystal unit FE. The example in FIG. 3 illustrates four views of the image as recorded by an image-recording device (not depicted). The four views are processed by appropriate software in the autostereoscopic display device and assigned to a pixel field of the liquid crystal unit FE. For simplicity, FIG. 3 shows only a one-dimensional pixel field, which has a plurality of elementary pixels EP. Each elementary pixel EP includes a red subpixel SP, a green subpixel SP and a blue subpixel SP. A front polarizer FP with an anti-reflective coating AS is arranged between the liquid crystal unit FE and a wave-selective filter (slotted shadow mask) WF. The anti-reflective coating AS causes multiple views of the pixel field to be “mixed.” Accordingly, the image will appear blurred to the viewer. In the example illustrated in FIG. 3, the blue color of a third view, the red color of a fourth view and the green color of a first view are mixed.

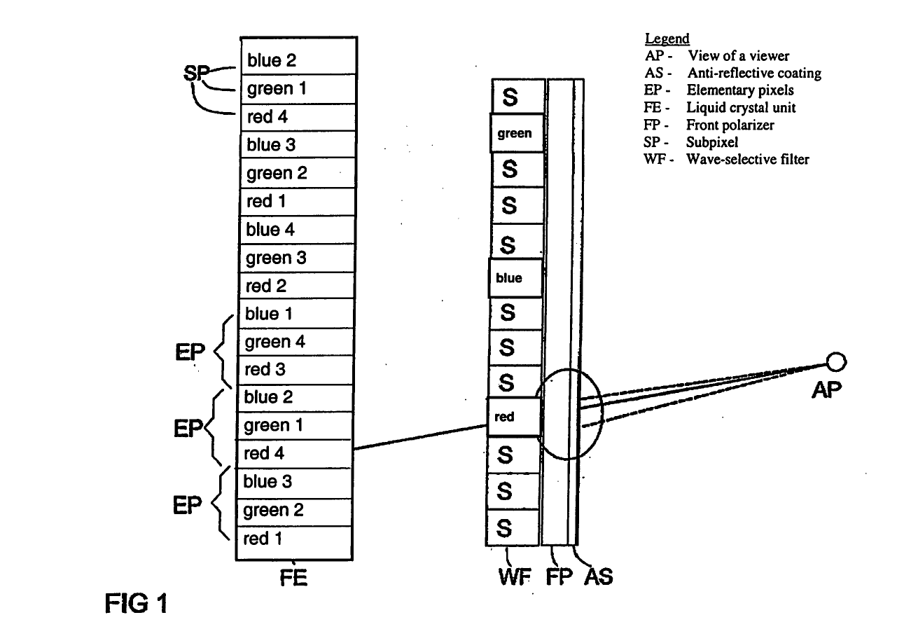

As illustrated in FIG. 1, the interfering influences on the sharpness of the image caused by the anti-reflective coating AS are avoided by disposing the wave-selective filter WF between the liquid crystal unit FE and the front polarizer FP, which is provided with the anti-reflective coating AS. Thus, the anti-reflective coating will scatter only the “sharp” image. Therefore, when compared to an autostereoscopic display device of the prior art, the arrangement illustrated in FIG. 1 provides a very good representation of the image displayed on the liquid crystal unit FE.

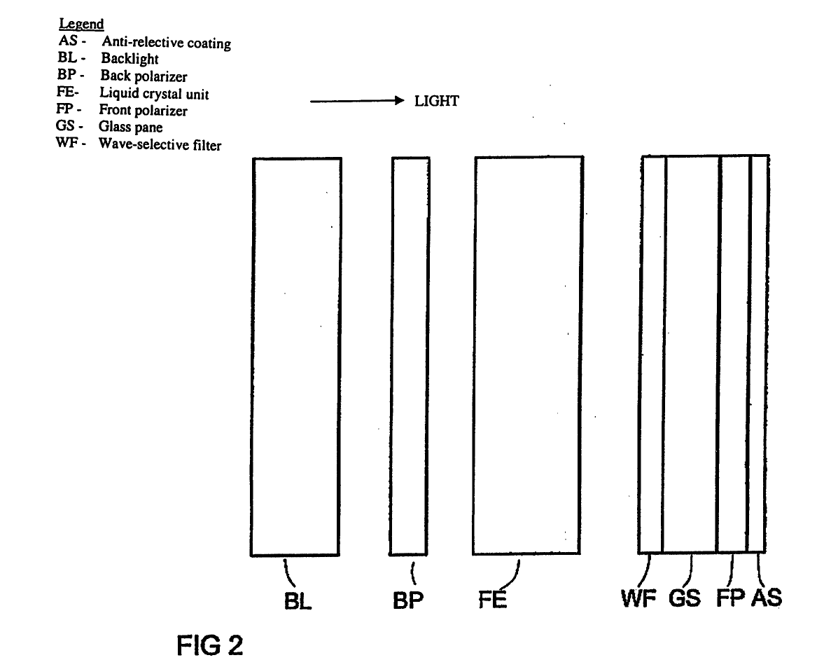

FIG. 2 illustrates a schematic diagram of an autostereoscopic display device consistent with the present invention. The autostereoscopic display device includes a backlight BL, a back polarizer BP, a liquid crystal unit FE and a glass pane GS. A wave-selective filter WF and a front polarizer FP with an anti-reflective coating AS are disposed on the glass pane GS. The wave-selective filter WF, the glass pane GS, which stabilizes the front polarizer FP, and the front polarizer FP with the anti-reflective coating AS form a composite unit.

The above description of the preferred embodiments has been given by way of example. From the disclosure given, those skilled in the art will not only understand the present invention and its attendant advantages, but will also find apparent various changes and modifications to the structures disclosed. It is sought, therefore, to cover all such changes and modifications as fall within the spirit and scope of the invention, as defined by the appended claims, and equivalents thereof.

1. An autostereoscopic display comprising:
a backlight supplying light;
a back polarizer accepting the light supplied by the backlight;
a liquid crystal unit disposed downstream of the back polarizer with respect to the direction of travel of the light;
a wave-selective filter; and
a front polarizer comprising an anti-reflective coating,
wherein the wave-selective filter is disposed between the liquid crystal unit and the front polarizer.

2. The autostereoscopic display as claimed in claim 1, wherein the wave-selective filter, the front polarizer and the anti-reflective coating are components of a composite unit provided with a glass pane, and
wherein the glass pane is disposed between the wave-selective filter and the front polarizer.

3. An autostereoscopic display comprising:
a liquid crystal unit;
a wave-selective filter; and
a front polarizer comprising an anti-reflective coating,
wherein the wave-selective filter is disposed between the liquid crystal unit and the front polarizer.

4. The autostereoscopic display as claimed in claim 3, wherein the wave-selective filter, the front polarizer and the anti-reflective coating are components of a composite unit further comprising a glass pane, and
wherein the glass pane is disposed between the wave-selective filter and the front polarizer.
